(19) United States
(12) Patent Application Publication
(10) Pub. No.: US 2004/0138980 A1
(43) Pub. Date: Jul. 15, 2004

(54) Direct participation business model

(76) Inventor: Robert Bender, Ottawa (CA)

Correspondence Address: LAHIVE & COCKFIELD, LLP., 28 STATE STREET, BOSTON, MA, 02109, US

(21) Appl. No.: 10/612,486

(22) Filed: Jul. 2, 2003

Related U.S. Application Data
(60) Provisional application No. 60/393,222, filed on Jul. 2, 2002.

(51) Int. Cl. G06F 17/60

(52) U.S. Cl. 705/36

(57) ABSTRACT

The invention pertains, at least in part to a business structure comprising a managed fund, wherein said fund does not pay fees to a General Partner, and wherein the General Partner has a significant investment in the managed fund; and investment of the managed fund via convertible debt.

### RELATED APPLICATIONS

This patent application claims priority to U.S.S.No. 60/393,222, filed Jul. 2, 2002, entitled “Direct Participation Business Model,” incorporated herein by reference in its entirety.

### BACKGROUND OF THE INVENTION

In early stage technology ventures there are some well documented structural problems which arise from the traditional funding model and the need for intensive management. Conventional venture funds are structured so that capital and company interests are separated and often adversarial. In addition, small capital pools are often ‘cannibalized’ due to the lack of incentive for other action by subsequent fund sources.

### SUMMARY

In one embodiment, the invention pertains to a business structure comprising a managed fund, wherein the fund does not pay fees to a General Partner and wherein the General Partner has an investment in said managed fund; and investment of the managed fund is through convertible debt or another instrument.

In another embodiment, the invention pertains, at least in part, to a method for funding a company. The method includes funding a company from an investment fund; and allowing a Principal of the fund to develop and manage a company, wherein the Principal has common equity in the company.

### DETAILED DESCRIPTION

In an embodiment, the invention pertains to a novel way to structure interactions between investors and early stage technology companies to avoid the problems associated with the traditional funding model and create a more favorable alignment between the interests of companies, technology entrepreneurs and investors. Preferably, the managed fund does not charge management fees on capital and has no ‘carry.’ Fund principals manage the capital and may be required to contribute a significant percentage of the capital. Pure capital providers have the right but no obligation to participate in subsequent financings which, however, may not be done by the Fund itself. The fund invests only via convertible notes which are converted at subsequent financings at a set discount; subsequent financings must be priced arms-length by third parties. Capital providers have the obligation to take on any subsequent ‘play or pay’ obligations of the fund (e.g., pro rata) if they participate but no other investment obligations. Fund principals (the Fund) take their compensation via common equity; fees are directly billed to investees as incurred.

In one embodiment, the invention pertains to a method of direct participation by Fund Principals in the management and development of start-up and early stage companies for compensation via common equity in the company. Preferably, the Fund Principals have significant equity in the company, e.g., 5-10% or greater. Parallel direct capital investment by the Principals on identical terms to those of capital providers is part of the overall deal structure. The methods of the invention align of interests of all stakeholders so as to promote shared economic success and avoid conflicting incentives.

Few early stage technology companies can achieve economic operation without significant capital to fund initial development expenses. The combination of the aggregate amount of capital required and the ability to stage investments according to risk-retum estimates has created a tiered funding structure which is common throughout the technology sector that is funded by traditional venture capital sources.

Venture capital, in its institutional form, has evolved into specialized activities characterized as to stage of company development and type of financial instrument employed. Classical Venture Capital typically funds 2-4 stages of company development at increasing dollar amounts per stage.

The ‘standard model’ Venture Fund is a managed pool, which is usually in partnership form. Expenses and a management fee are generally charged to the pool and the general partner usually has a carried interest in the success of the pool. This model rewards the general partner for increasing the size of the pool and generally creates a disincentive to make small investments in relation to the size of the pool. In addition, the primary incentives for investment include minimizing the entry cost base. As the Venture industry has developed, successful funds have grown in size (dollars under management) and therefore are less motivated and able to take on early stage development situations.

Many early stage technology companies are ‘pre venture capital’ at their inception. Traditionally these companies have been funded by family and friends of the founding entrepreneurs together with ‘Angel’ (non institutional) investors. These sources are generally limited and are sometimes joined by small institutional funds (Seed Venture Funds). Two difficulties present themselves at this stage:

1) The available pool of capital is limited and not capable of following through the next stages of development—in contrast, the larger pools are not attracted to relatively small investment opportunities; and

2) Due to the limited fees available to pay for fund management expertise in relation to qualification and management of these early stage situations is not generally available.

Management of the early stages of development of technology companies is demanding of both technical and organizational skills. Furthermore, it requires intensive involvement and substantial time commitments. These are factors which mitigate against the involvement of larger capital pools.

The combined result of these factors is that the first institutional investment tier (aka Seed Stage) is, increasingly, unattractive to larger Venture Funds and untenable for smaller funds. The situation is exacerbated by the inability of smaller funds to maintain their participation in deals as they progress through larger capital requirements. Commonly, a smaller fund will be ‘diluted out’ or reduced to a de-minimus participation through play-or-pay provisions in subsequent stages of financing. Efforts to protect the interests of smaller funds which usually focus on changing the relative participation of the Seed Capital to that of founders and management are counterproductive in terms of development of a viable business entity since they create adversarial relationships between the investors and the Company.

These factors have created a recognized shortage of qualified Seed Venture Capital in the technology sector which is not addressed in a systematic way by the current investment and development model.

In one embodiment, the invention pertains to a financing and management structure which may avoid a number of the difficulties stated above.

The structure comprises:

a managed fund which does not pay fees to the General Partner (GP) (and thus is not scale sensitive per se) and in which the GP has a significant (e.g., about 5-10% or greater) investment thereby creating a common interest with the balance of the capital pool;

a ‘fund’ of management and/or relevant technical expertise in the GP;

investment via convertible debt or other instrument with valuation to be determined (at conversion) by third party investors; and

compensation of the GP on the same basis as founders and other management thereby aligning the long term interest of the GP with the company.

The split involvement and incentives of the GP through both capital and management participation explicitly avoids the traditional difficulties of conflicting interests of capital and the Company and Management. In operation, subsequent capital, if provided by participants in the Fund, and if required, should have the obligation to take on ‘play or pay’ obligations of the Fund. Additionally, contractual restrictions may be added to limit management compensation if it is due to the GP.

The structure outlined above creates incentives for direct managerial participation by the GP without forcing commitment of large amounts of capital. It also creates incentives management to work with the Fund in a long term alignment which is maintained through subsequent stages of financing.

1. A business structure comprising:
a managed fund, wherein said fund does not pay fees to a General Partner and wherein said General Partner has an investment in said managed fund; and
investment of said managed fund via convertible debt or another instrument.

2. The business structure of claim 1, wherein said General Partner is compensated on the same basis as Founders and Management.

3. The business structure of claim 1, wherein said convertible debt is valued by third party investors.

4. The business structure of claim 1, wherein said General Partner further comprises management or relevant technical expertise.

5. The business structure of claim 1, wherein said General Partner owns 5-10% of said company.

6. A method for funding a company, comprising:
funding a company from an investment fund;
allowing a Principal of said fund to develop and manage a company, wherein said Principal has common equity in said company.
